(19) United States
(12) Patent Application Publication
(10) Pub. No.: US 2011/0041646 A1
(43) Pub. Date: Feb. 24, 2011

(54) Handlebar Clamping Device for Bicycle

(76) Inventor: Yung-Chien Huang, Changhua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/546,035

(22) Filed: Aug. 24, 2009

(51) Int. Cl. B62K 21/26

(52) U.S. Cl. 74/551.9

(57) ABSTRACT

A handlebar clamping device for a bicycle includes a handlebar, a mounting tube mounted on the handlebar and having a peripheral wall provided with two opposite mounting portions and two opposite openings located between the two mounting portions, and a clamping unit extending through the two openings of the mounting tube and pressing the handlebar to lock the mounting tube onto the handlebar. Thus, the handlebar clamping device only needs to provide a single clamping unit to lock the mounting tube onto the handlebar, thereby decreasing the cost of fabrication of the handlebar clamping device.

### BACKGROUND OF THE INVENTION

1. Field of the Invention

The present invention relates to a clamping device and, more particularly, to a handlebar clamping device for a bicycle.

2. Description of the Related Art

A conventional handlebar clamping device for a bicycle in accordance with the prior art shown in FIG. 5 comprises a handlebar 45, a grip 40 and two clamping members 43. The grip 40 includes an inner tube 41 mounted on the handlebar 45 and having two opposite ends each provided with two clamping pieces 411 and a protective jacket 42 mounted on the inner tube 41. Each of the two clamping members 43 is mounted on the two opposite ends of the inner tube 41 and has an inner wall pressing the respective clamping pieces 411 of the inner tube 41 to lock the inner tube 41 of the grip 40 onto the handlebar 45. Each of the clamping members 43 has a C-shaped profile and is pressed on the respective clamping pieces 411 of the inner tube 41 by a locking bolt 44. However, the conventional handlebar clamping device needs to provide two clamping members 43 to lock the inner tube 41 of the grip 40 onto the handlebar 45, thereby increasing the cost of fabrication of the handlebar clamping device.

### BRIEF SUMMARY OF THE INVENTION

In accordance with the present invention, there is provided a handlebar clamping device for a bicycle, comprising a handlebar, a mounting tube mounted on the handlebar and having a peripheral wall provided with two opposite mounting portions and two opposite openings located between the two mounting portions, and a clamping unit extending through the two openings of the mounting tube and pressing the handlebar to lock the mounting tube onto the handlebar.

According to the primary objective of the present invention, the locking portions of the two clamping members are forced by the fastening bolt to move toward each other, and the two clamping members of the clamping unit are moved toward the mounting tube, so that the inner wall of each of the two clamping members extends through the respective opening of the mounting tube and presses the handlebar so as to lock the mounting tube onto the handlebar.

According to another objective of the present invention, the pressing recess of each of the two clamping members presses the respective mounting portion of the mounting tube toward the handlebar so that the mounting tube is locked onto the handlebar solidly and stably.

According to a further objective of the present invention, the handlebar clamping device only needs to provide a single clamping unit to lock the mounting tube onto the handlebar, thereby decreasing the cost of fabrication of the handlebar clamping device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a handlebar clamping device for a bicycle in accordance with the preferred embodiment of the present invention.

FIG. 2 is an exploded perspective view of the handlebar clamping device for a bicycle as shown in FIG. 1.

FIG. 3 is a side cross-sectional view of the handlebar clamping device for a bicycle as shown in FIG. 1.

FIG. 4 is a partially top cross-sectional view of the handlebar clamping device for a bicycle as shown in FIG. 1.

FIG. 5 is an exploded perspective view of a conventional handlebar clamping device for a bicycle in accordance with the prior art.

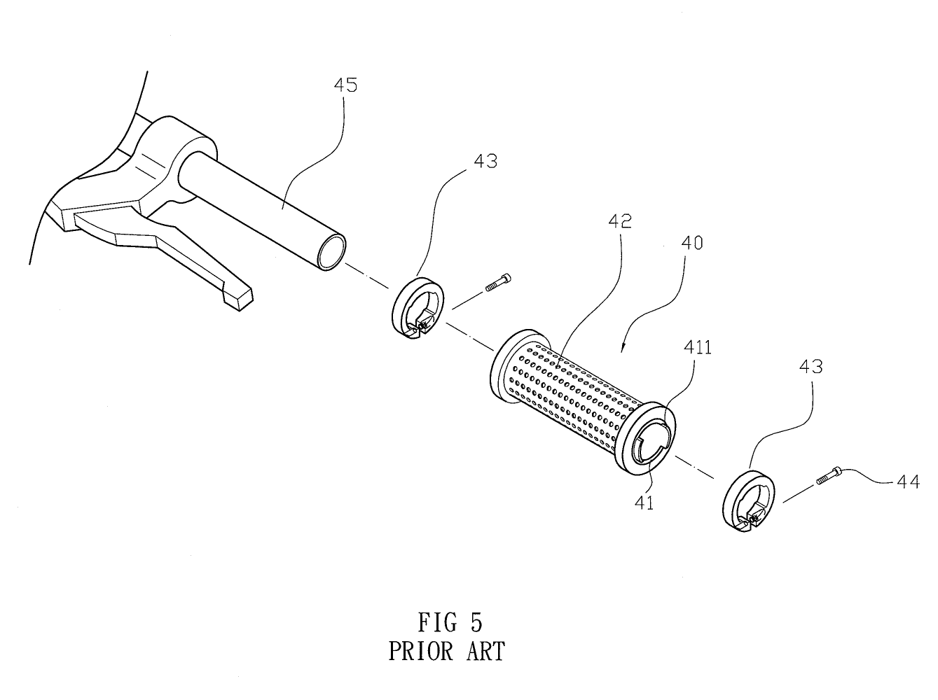

### DETAILED DESCRIPTION OF THE INVENTION

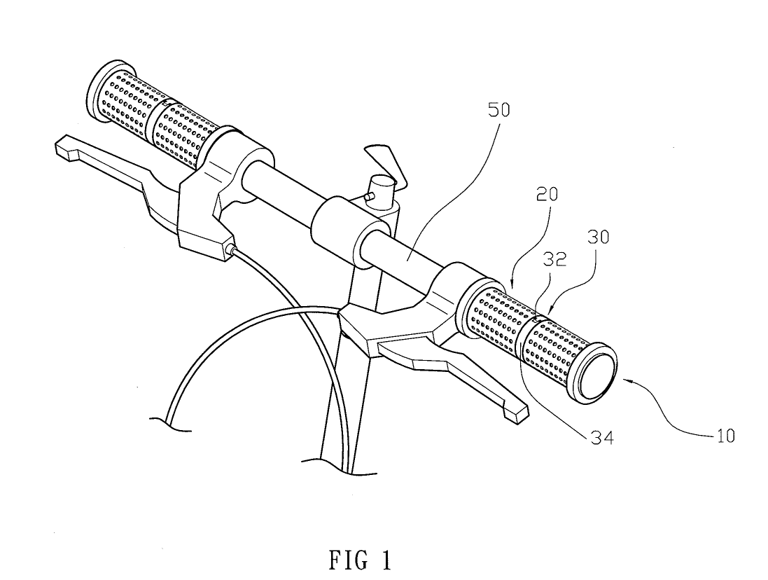

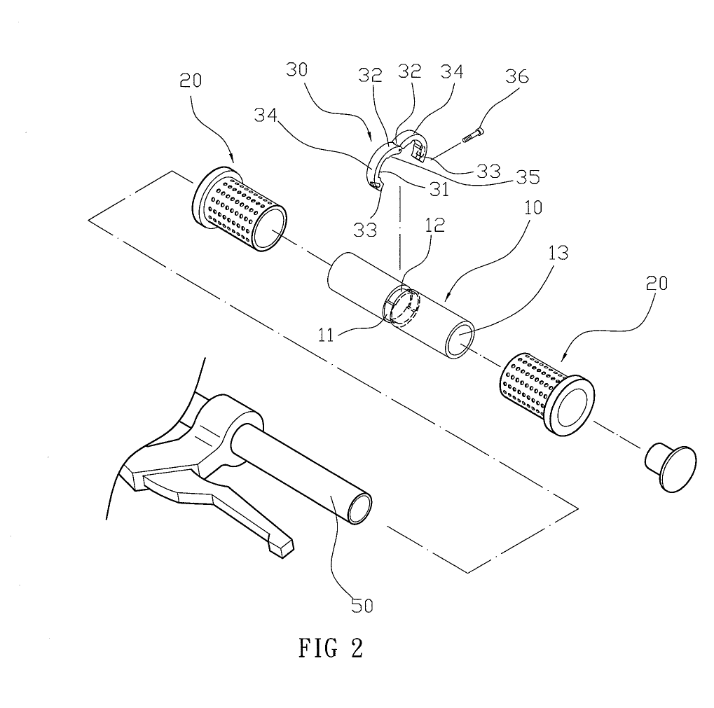

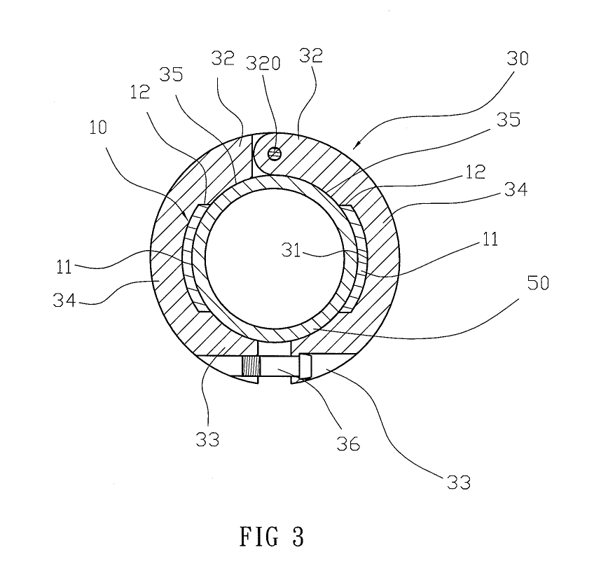

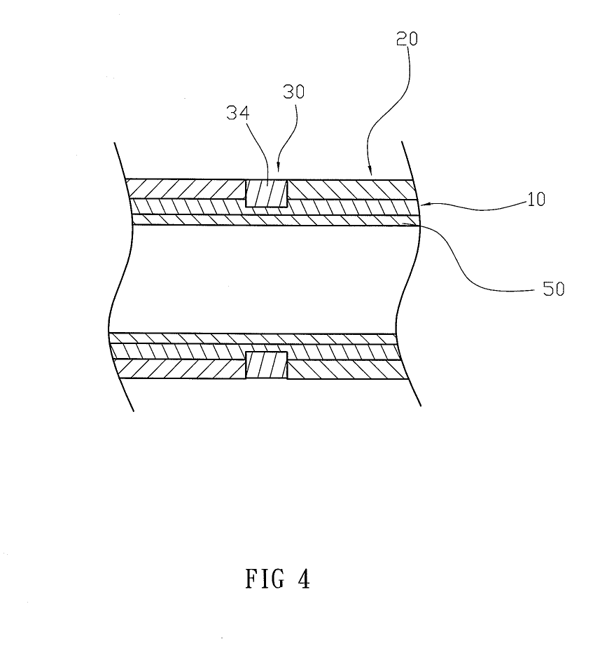

Referring to FIGS. 1-4, a handlebar clamping device for a bicycle in accordance with the preferred embodiment of the present invention comprises a handlebar 50, a mounting tube 10 mounted on the handlebar 50 and having a peripheral wall provided with two opposite mounting portions 11 and two opposite openings 12 located between the two mounting portions 11, a clamping unit 30 extending through the two openings 12 of the mounting tube 10 and pressing the handlebar 50 to lock the mounting tube 10 onto the handlebar 50, and two protective jackets 20 mounted on the mounting tube 10 and abutting the clamping unit 30.

The mounting tube 10 is made of a hard material, such as the plastic material and the like. Preferably, the mounting tube 10 is integrally formed by a plastic injection molding process. The mounting tube 10 has an inner portion provided with a mounting hole 13 mounted on the handlebar 50 and connected to the two openings 12. The mounting portions 11 of the mounting tube 10 are formed on a middle position of the mounting tube 10. Each of the two mounting portions 11 of the mounting tube 10 has a substantially arc-shaped profile.

Each of the two protective jackets 20 is made of a soft material, such as rubber, cloth, foam material and the like. Preferably, each of the two protective jackets 20 is bonded onto the mounting tube 10 by an adhesive. Alternatively, each of the two protective jackets 20 is directly formed on the mounting tube 10 by an injection forming process.

The clamping unit 30 is located between the two protective jackets 20 and has an outer wall flush with that of each of the two protective jackets 20. The clamping unit 30 includes two clamping members 34 which are pivotally connected with each other and are mounted on the two mounting portions 11 of the mounting tube 10. Each of the two clamping members 34 of the clamping unit 30 has a substantially arc-shaped profile. Each of the two clamping members 34 of the clamping unit 30 has a first end provided with a pivot portion 32 and a second end provided with a locking portion 33. The pivot portions 32 of the two clamping members 34 are pivotally connected with each other by a pivot pin 320. The locking portions 33 of the two clamping members 34 are combined by a fastening bolt 36. Each of the two clamping members 34 of the clamping unit 30 has an inner wall 35 that extends through a respective one of the two openings 12 of the mounting tube 10 and presses the handlebar 50 to lock the mounting tube 10 onto the handlebar 50. The inner wall 35 of each of the two clamping members 34 has a surface provided with a pressing recess 31 pressing a respective one of the two mounting portions 11 of the mounting tube 10 toward the handlebar 50.

In operation, when the two clamping members 34 of the clamping unit 30 are tightened by the fastening bolt 36, the locking portions 33 of the two clamping members 34 are forced by the fastening bolt 36 to move toward each other, and the two clamping members 34 of the clamping unit 30 are moved toward the mounting tube 10, so that the inner wall 35 of each of the two clamping members 34 extends through the respective opening 12 of the mounting tube 10 and presses the handlebar 50 so as to lock the mounting tube 10 onto the handlebar 50. At this time, the pressing recess 31 of each of the two clamping members 34 presses the respective mounting portion 11 of the mounting tube 10 toward the handlebar 50 so that the mounting tube 10 is locked onto the handlebar 50 solidly and stably.

Accordingly, the locking portions 33 of the two clamping members 34 are forced by the fastening bolt 36 to move toward each other, and the two clamping members 34 of the clamping unit 30 are moved toward the mounting tube 10, so that the inner wall 35 of each of the two clamping members 34 extends through the respective opening 12 of the mounting tube 10 and presses the handlebar 50 so as to lock the mounting tube 10 onto the handlebar 50. In addition, the pressing recess 31 of each of the two clamping members 34 presses the respective mounting portion 11 of the mounting tube 10 toward the handlebar 50 so that the mounting tube 10 is locked onto the handlebar 50 solidly and stably. Further, the handlebar clamping device only needs to provide a single clamping unit 30 to lock the mounting tube 10 onto the handlebar 50, thereby decreasing the cost of fabrication of the handlebar clamping device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A handlebar clamping device for a bicycle, comprising:
a handlebar (50);
a mounting tube (10) mounted on the handlebar and having a peripheral wall provided with two opposite mounting portions (11) and two opposite openings (12) located between the two mounting portions;
a clamping unit (30) extending through the two openings of the mounting tube and pressing the handlebar to lock the mounting tube onto the handlebar.

2. The handlebar clamping device for a bicycle of claim 1, further comprising:
two protective jackets (20) mounted on the mounting tube and abutting the clamping unit.

3. The handlebar clamping device for a bicycle of claim 1, wherein
the clamping unit includes two clamping members (34) which are pivotally connected with each other;
each of the two clamping members of the clamping unit has an inner wall (35) that extends through a respective one of the two openings of the mounting tube and presses the handlebar to lock the mounting tube onto the handlebar.

4. The handlebar clamping device for a bicycle of claim 3, wherein the inner wall of each of the two clamping members has a surface provided with a pressing recess (31) pressing a respective one of the two mounting portions of the mounting tube toward the handlebar.

5. The handlebar clamping device for a bicycle of claim 3, wherein
each of the two clamping members of the clamping unit has a first end provided with a pivot portion (32) and a second end provided with a locking portion (33);
the pivot portions of the two clamping members are pivotally connected with each other by a pivot pin (320);
the locking portions of the two clamping members are combined by a fastening bolt (36).

6. The handlebar clamping device for a bicycle of claim 1, wherein the mounting portions of the mounting tube are formed on a middle position of the mounting tube.

7. The handlebar clamping device for a bicycle of claim 3, wherein the two clamping members of the clamping unit are mounted on the two mounting portions of the mounting tube.

8. The handlebar clamping device for a bicycle of claim 7, wherein each of the two clamping members of the clamping unit has a substantially arc-shaped profile.

9. The handlebar clamping device for a bicycle of claim 8, wherein each of the two mounting portions of the mounting tube has a substantially arc-shaped profile.

10. The handlebar clamping device for a bicycle of claim 2, wherein the clamping unit is located between the two protective jackets.

11. The handlebar clamping device for a bicycle of claim 2, wherein the clamping unit has an outer wall flush with that of each of the two protective jackets.

12. The handlebar clamping device for a bicycle of claim 1, wherein the mounting tube has an inner portion provided with a mounting hole mounted on the handlebar.

13. The handlebar clamping device for a bicycle of claim 12, wherein the mounting hole of the mounting tube is connected to the two openings.

14. The handlebar clamping device for a bicycle of claim 1, wherein the mounting tube is made of a plastic material.

15. The handlebar clamping device for a bicycle of claim 1, wherein the mounting tube is integrally formed by a plastic injection molding process.

16. The handlebar clamping device for a bicycle of claim 2, wherein each of the two protective jackets is made of rubber or cloth.
